(19) United States
(12) Patent Application Publication
(10) Pub. No.: US 2009/0249376 A1
(43) Pub. Date: Oct. 1, 2009

(54) OPTICAL DISC APPARATUS

(75) Inventor: Naoki Eguchi, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/367,996

(22) Filed: Feb. 9, 2009

(30) Foreign Application Priority Data
Mar. 31, 2008 (JP) 2008-091721

(51) Int. Cl. G11B 17/04

(52) U.S. Cl. 720/619; G9B/17.013

(57) ABSTRACT

According to one embodiment, an optical disc apparatus includes a disc motor configured to hold and rotate an optical disc, a motor support mechanism configured to support the disc motor to be movable, a motor lift mechanism configured to ascend and descend the disc motor among a ascending position, a descending position, and a disc drive position between the ascending position and the descending position, a clamp release member arranged to be movable between a clamp release position, at which the clamp release member contacts with the optical disc to regulate movement of the optical disc, and an evacuate position at which the clamp release member is separated from the optical disc, and a release member lift mechanism configured to ascend and descend the clamp release member in synchronism with the ascent and descent of the disc motor.

### CROSS-REFERENCE TO RELATED APPLICATIONS

This application is based upon and claims the benefit of priority from Japanese Patent Application No. 2008-091721, filed Mar. 31, 2008, the entire contents of which are incorporated herein by reference.

### BACKGROUND

1. Field

One embodiment of the present invention relates to an optical disc apparatus for recording and reproducing information on and from a disc-shaped information recording medium, for example, an optical disc.

2. Description of the Related Art

Recently, an optical disc apparatus for recording and reproducing information on and from an optical disc such as a CD (Compact Disc), a DVD (Digital Versatile Disc) and the like is widely known as an information recording and reproducing apparatus.

An optical disc apparatus, for example, a slim type optical disc apparatus built in a computer has a cabinet formed in a flat rectangular box shape, a motor and a turntable for supporting and rotating an optical disc, a drive unit of an optical pick-up and the like which records and reproduces information on and from the optical disc placed on the turntable, a disc loading mechanism for drawing in the optical disc to a predetermined position in the optical disc apparatus and securely ejecting the optical disc, a disc motor for rotating the optical disc, and the like.

The disc loading mechanism is roughly classified into a tray type, which has a tray on which an optical disc or a cartridge having an optical disc accommodated therein is placed and in which the optical disc can be placed on the tray by projecting the tray from the apparatus, and a slot-in type in which the optical disc is drawn into the apparatus.

Since the slot-in type disc loading mechanism can reduce the thickness of an optical disc apparatus, it is widely used in a built-in type optical disc apparatus represented by an audio-video system mounted on a vehicle and the like and by a mobile type personal computer and the like.

In the slot-in type disc loading mechanism, when an optical disc is loaded, a turntable and a motor ascend from a predetermined position, and the optical disc is supported at a predetermined position by engaging a clamp portion of the loading mechanism with the optical disc. Further, when the optical disc is released and ejected from the turntable, the turntable and the motor descend together with the optical disc, and the optical disc is locked to a sheet-shaped disc cover fixedly arranged at a predetermined position. In this state, when the turntable and the motor are caused to further descend, the optical disc is released from the clamp portion of the turntable (for example, Jpn. Pat. Appln. KOKAI Publication No. 2004-39193).

However, when the disc cover is fixedly provided at the predetermined position in the apparatus as in the above optical apparatus in order to release the optical disc, it is difficult to position the disc cover at a position optimum to load and release the optical disc. That is, as the thickness of an optical disc apparatus is reduced, since the ascending and descending strokes of the turntable and the motor cannot be set to a large amount, and thus it is difficult to sufficiently secure a clearance between the disc cover and other mechanical parts and between the optical disc and other mechanical parts. Accordingly, there is a possibility that when a shock or the like acts on the optical disc apparatus, the disc cover interferes with other mechanical parts.

It is difficult to sufficiently secure a distance, that is, a lap amount, for the turntable to further descend after the optical disc engages with the disc cover. To securely release the optical disc clamped to the clamp portion of the turntable, it is preferable to sufficiently secure the lap amount.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an internal structure of an optical disc apparatus according to an embodiment of the present invention with a top cover thereof removed;

FIG. 2 shows an exemplary partially exploded perspective view of a disc motor, a motor support mechanism, a motor lift mechanism, and a clamp release slider of the optical disc apparatus;

FIG. 3 is an exemplary perspective view showing a cam member and a clamp release slider of the motor lift mechanism with a part of the disc motor removed;

FIG. 4 is an exemplary perspective view of the disc motor when viewed from a bottom thereof;

FIG. 5 is an exemplary perspective view showing the cam member;

FIG. 6 is an exemplary sectional view schematically showing the relation among the disc motor, a clamp ring, and other peripheral members;

FIG. 7 is an exemplary perspective view showing the disc motor, the clamp ring, and a cam drive mechanism;

FIGS. 8A and 8B are an exemplary perspective view and an exemplary sectional view of the optical disc apparatus showing a state when a disc is driven;

FIGS. 9A and 9B are an exemplary perspective view and an exemplary sectional view of the optical disc apparatus showing a state when a clamp release operation is started;

FIGS. 10A and 10B are an exemplary perspective view and an exemplary sectional view of the optical disc apparatus showing a state when a clamp is released;

FIGS. 11A and 11B are an exemplary perspective view and an exemplary sectional view of the optical disc apparatus showing a state when a disc is separated; and

FIGS. 12A and 12B are an exemplary perspective view and an exemplary sectional view of the optical disc apparatus showing a state when the clamp release operation is completed and a disc conveyance is waited.

### DETAILED DESCRIPTION

Various embodiments according to the invention will be described hereinafter with reference to the accompanying drawings. In general, according to one embodiment of the invention, an optical disc apparatus comprises: a disc motor comprising a turntable on which an optical disc is to be placed and a clamp portion which is configured to clamp the optical disc placed on the turntable, and configured to hold and rotate the optical disc; a motor support mechanism configured to support the disc motor to be movable; a motor lift mechanism configured to ascend and descend the disc motor among a ascending position, at which the clamp portion clamps the optical disc, a descending position, at which the disc motor is separated from the optical disc, and a disc drive position between the ascending position and the descending position, with respect to the optical disc loaded at a predetermined position; a clamp release member arranged to be movable between a clamp release position, at which the clamp release member contacts with the optical disc to regulate movement of the optical disc, and an evacuate position at which the clamp release member is separated from the optical disc; and a release member lift mechanism configured to ascend and descend the clamp release member in synchronism with the ascent and descent of the disc motor.

An optical disc apparatus according to an embodiment of the present invention will be explained in detail with reference to the drawings.

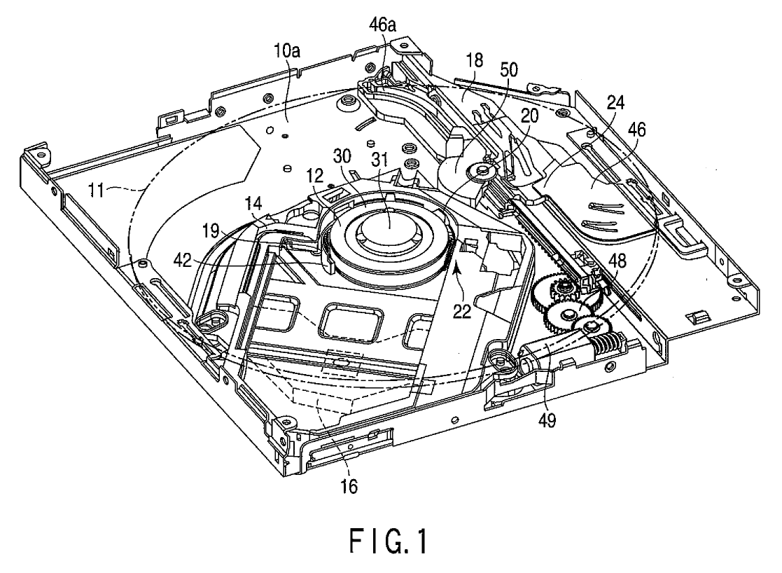

FIG. 1 shows an internal structure of the optical disc apparatus according to the embodiment with a top cover thereof removed. As shown in FIG. 1, the optical disc apparatus is arranged as a slot-in type optical disc apparatus that is built in, for example, a portable personal computer and the like. The optical disc apparatus has a bottom cover 10a serving as a base and a not shown top cover that covers an upper opening of the bottom cover. The bottom cover 10a is formed of a metal plate in an approximately rectangular shape, and a side wall is formed by bending a peripheral edge portion thereof at approximately right angles. The bottom cover 10a has an area larger than that of an optical disc 11 to be mounted.

A disc motor 12 is provided at an approximately central portion of the bottom cover 10a to support and rotate an optical disc 11. A mechanical chassis 14 is arranged around the disc motor 12. On the mechanical chassis 14 are mounted an optical pick-up (optical head) 16 and a not shown head drive mechanism. The optical pick-up 16 radiates a laser beam to the optical disc 11 to record and reproduce information, and the head drive mechanism moves the optical pick-up in a diameter direction of the optical disc 11.

On the bottom cover 10a are provided a motor lift mechanism 18, a clamp release slider 20, a slider lift mechanism 22 as a release member lift mechanism, and a cam drive mechanism 24. The motor lift mechanism 18 causes the disc motor 12 to ascend and descend in a direction parallel to a rotating shaft of the disc motor 12, and the cam drive mechanism 24 drives the motor lift mechanism 18 and the slider lift mechanism 22. Further, on the bottom cover 10a is provided a not shown loading mechanism which loads the optical disc 11 in the apparatus and ejects the optical disc 11 to the outside from the apparatus.

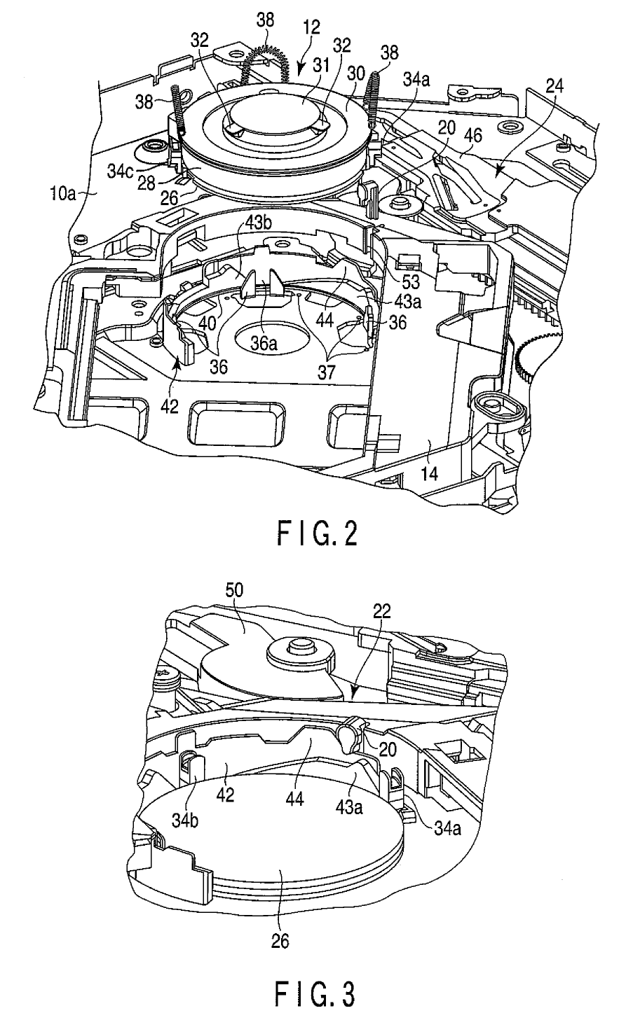

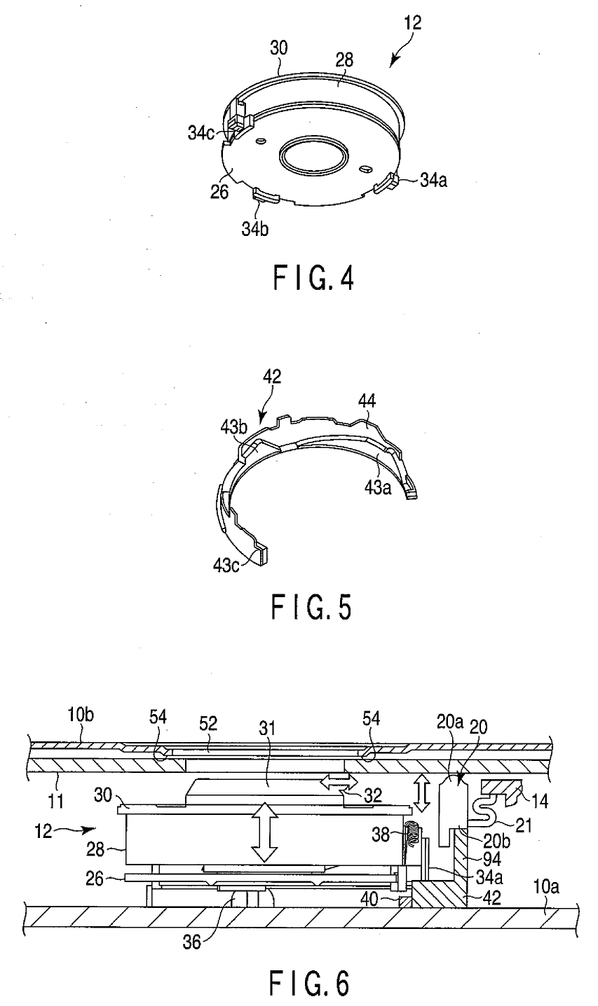

FIG. 2 shows the disc motor, a motor support mechanism, the motor lift mechanism, and the clamp release slider with parts thereof exploded, and FIG. 3 shows a cam member of the motor lift mechanism and the clamp release slider with a part of the disc motor removed. FIG. 4 shows the disc motor when it is viewed from a bottom thereof, and FIG. 5 shows the cam member. FIG. 6 schematically shows the relation among the disc motor, a clamp ring, and other peripheral members.

As shown in FIGS. 1 to 4, the disc motor 12 has a disc-shaped bottom plate 26, a cylindrical motor case 28 located on the bottom plate, and a turntable 30 attached to a rotating shaft of the motor 12. A circular hub 31 projects from a central portion of the turntable 30 so as to be engaged with an inner hole of the optical disc 11. Ball chucking claws 32 are formed at three positions in an outer periphery of the hub 31. These ball chucking claws 32 chuck an inner peripheral edge of the optical disc 11 in a state that the hub 31 is inserted into the inner hole of the optical disc 11 and clamp the optical disc 11 on the turntable 30. The hub 31 and the ball chucking claws 32 constitute a clamp portion.

Cam-contacting projections 34a, 34b, 34c are fixed at three positions in an outer peripheral edge of the bottom plate 26. These cam-contacting projections 34a, 34b, 34c are disposed at intervals of, for example, about 90 or more in a circumferential direction, extend in a direction parallel to the central axis of the disc motor 12, respectively, and are disposed slightly outside of the motor case 28. Lower ends of the respective cam-contacting projections 34a, 34b, 34c form engaging portions which are engaged with cams to be described later, and upper ends thereof form spring hook portions to which springs are hooked.

In contrast, as shown FIGS. 1 to 3 and FIGS. 5 and 6, the bottom cover 10a has three plate-shaped lift guides 36 standing from a central portion thereof, and the respective lift guides have guide slits 36a perpendicularly extending with respect to the bottom cover 10a. In the bottom cover 10a, spring hook holes 37 are formed on both sides of each lift guide 36.

An arc-shaped ring guide rib 40 projects from the bottom cover 10a outside of the three lift guides 36 and extend approximately coaxially with the central axis of the disc motor 12. An arc-shaped clamp ring 42 acting as a cam member is placed on the bottom cover 10a and guided by the ring guide rib 40 so that it can rotate around the central axis of the disc motor 12. With this arrangement, the clamp ring 42 is located outside of the disc motor 12 at slight intervals.

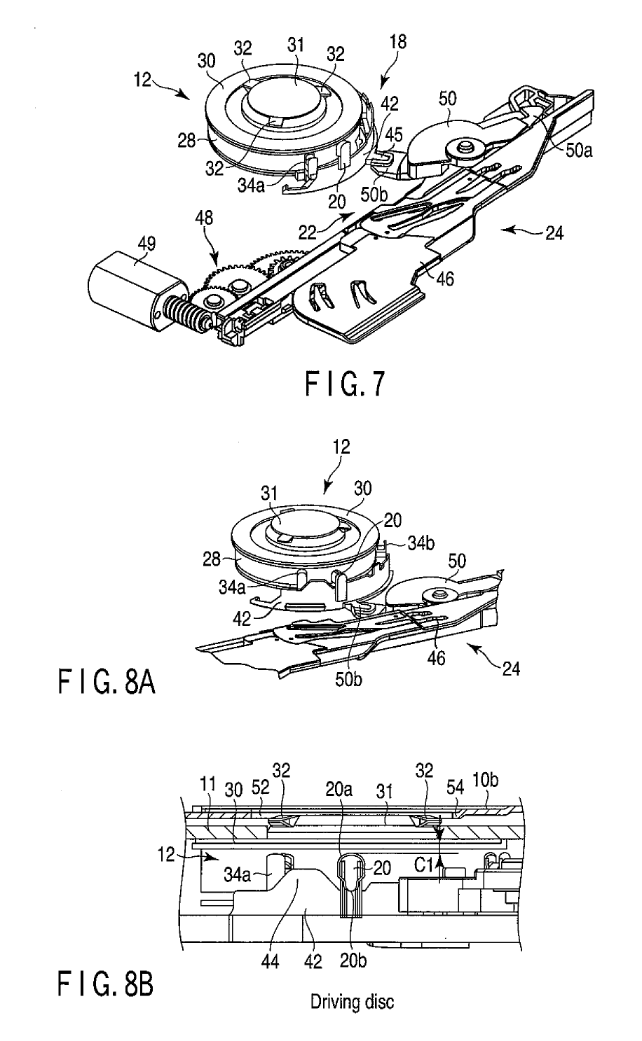

As shown in FIGS. 2, 3, 5, and 6, the clamp ring 42 has three lift cams 43a, 43b, and 43c formed thereto. These lift cams 43a, 43b, 43c are separated from each other in a circumferential direction of the clamp ring 42 and located to have a positional relation corresponding to the cam-contacting projections 34a, 34b, 34c disposed on the bottom plate 26 of the motor 12. The clamp ring 42 has a release cam 44 located outside of the lift cam 43a. The release cam 44 is arranged such that it is dislocated by a predetermined phase with respect to the lift cam 43a in the circumferential direction of the clamp ring 42. Further, as shown in FIG. 7, the clamp ring 42 has an engaging claw 45 which projects from an outer peripheral surface of the clamp ring 42 externally in the diameter direction. The clamp ring 42 is integrally molded of, for example, a synthetic resin.

As shown in FIGS. 1 to 3 and 6, the cam-contacting projections 34a, 34b, 34c of the disc motor 12 are respectively engaged in the corresponding guide slits 36a of the lift guides 36 so as to ascend and descend and guided thereby. With this arrangement, the position of the disc motor 12 is regulated in a plane direction of the bottom cover 10a by the lift guides 36 and the disc motor 12 is also supported by the lift guides 36 such that the disc motor 12 can ascend and descend in a direction parallel to the rotating shaft of the motor 12.

Biasing members, for example, coil springs 38 are hooked to the spring hook portions formed on the cam-contacting projections 34a, 34b, 34c of the disc motor 12 at central portions of the coil springs, and further both ends of each of the coil springs are locked in the spring hook holes 37. The cam-contacting projections 34a, 34b, 34c and the disc motor 12 are biased toward the bottom cover 10a side and the cam-contacting projections 34a, 34b, 34c are elastically pressed on the lift cam 43a, 43b, 43c of the clamp ring 42, respectively, by these three coil springs 38. With this arrangement, a position of the disc motor 12 in a height direction, that is, in a central axis direction is decided.

As described above, the lift guides 36, the clamp ring 42, the coil spring 38, and the cam-contacting projections 34a, 34b, 34c constitute a support mechanism 19 which supports the disc motor 12 to be ascend and descend.

As shown in FIGS. 1 and 7, the cam drive mechanism 24 is arranged outside of the mechanical chassis 14 on the bottom cover 10a to rotate the clamp ring 42 about the rotating shaft of the disc motor 12. The cam drive mechanism 24 has a cam slider 46, a loading motor 49, and a clamp lever 50. The cam slider 46 is arranged so that it can reciprocate in a direction perpendicular to the rotating shaft of the disc motor 12. The loading motor 49 moves the cam slider 46 through a gear train 48, and the clamp lever 50 is provided on the bottom cover 10a to be rotatable about a shaft parallel to the rotating shaft of the disc motor 12. The clamp lever 50 has a first engaging portion 50a engaged with a cam groove 46a of the cam slider 46 and a second engaging portion 50b engaged with the engaging claw 45 of the clamp ring 42.

When the loading motor 49 is driven, its driving force is transmitted to the cam slider 46 through the gear train 48, and the cam slider is slid linearly. With this operation, the clamp lever 50 is rotate by the cam slider 46, and the clamp ring 42 is rotated by the clamp lever. When the clamp ring 42 rotates and the lift cams 43a, 43b, 43c are moved, the cam-contacting projections 34a, 34b, 34c of the disc motor 12 are caused to ascend and descend along the lift cams, with a result that the disc motor 12 is caused to ascend and descend.

As described above, the clamp ring 42, the cam-contacting projections 34a, 34b, 34c, and the cam drive mechanism 24 constitute the motor lift mechanism 18 which causes the disc motor 12 to ascend and descend.

As shown in FIG. 6, a top cover 10b is arranged so as to cover an opening of the bottom cover 10a, and the top cover is opposed to the turntable 30 of the disc motor 12 with a space therebetween. A circular escape hole 52 is formed in the top cover 10b to escape the hub 31 when the disc motor 12 ascends. Further, locking ribs 54 are formed at an outer peripheral portion of the escape hole 52 so that it is brought into contact with an inner peripheral portion of the optical disc 11 and causes the optical disc 11 to be clamped to the ball chucking claws 32 of the hub 31.

Next, a clamp release mechanism for releasing clamp of the optical disc 11 will be explained. As shown in FIGS. 2, 3 and 6, the clamp release mechanism includes the clamp release slider 20 acting as a clamp release member. The clamp release slider 20 is engaged with a guide groove 53 formed in the mechanical chassis 14 and supported so that it can ascend and descend in a direction parallel to the rotating shaft of the disc motor 12.

A contacting projection 20a, which can contact with the inner peripheral portion of the optical disc 11, is formed at an upper end of the clamp release slider 20, and a cam contacting portion 20b, which is engaged with the release cam 44 of the clamp ring 42, is formed at an intermediate portion of the clamp release slider 20. The clamp release slider 20 is biased toward the bottom cover 10a side and the cam contacting portion 20b is elastically pressed to the release cam 44 by a resin spring 21 stretched between the clamp release slider 20 and the mechanical chassis 14. The resin spring 21 is molded of, for example, a synthetic resin and formed integrally with the clamp release slider 20.

When the clamp ring 42 is rotated by the cam drive mechanism 24, the clamp release slider 20 is caused to ascend and descend by the release cam 44 in synchronism with ascent and descent of the disc motor 12. Thus, the clamp release slider 20 is moved between a clamp release position wherein the contacting projection 20a is brought into contact with the inner peripheral portion of the optical disc 11 and regulates movement of the optical disc 11 and an evacuate position at which the contacting projection 20a is separated from the optical disc 11.

As described above, the clamp ring 42 having the release cam 44 and the cam drive mechanism 24 constitute the slider lift mechanism 22 which causes the clamp release slider 20 to ascend and descend in synchronism with ascent and descent of the disc motor 12. That is, the clamp ring 42 is pivoted by a slide operation of the cam slider 46 and drives the disc motor 12 and the clamp release slider 20 to ascend and descend so that the optical disc 11 is clamped and released.

Next, a disc clamp release operation of the optical disc apparatus arranged as described above will be explained. Here, five stages of the operation from a state that the disc is being driven to a state that the disc being clamped is released (disc eject waiting state) will be explained.

FIGS. 8A and 8B show a state that the optical disc 11 is placed on the turntable 30 of the disc motor 12 and clamped by the hub 31, that is, an operation state that the optical disc 11 is rotated by the disc motor 12. The disc motor 12 is held at a disc drive position, and the clamp release slider 20 descends and is held at the evacuate position. The optical disc 11 is held at a height having an appropriate clearance C1 from the top cover 10b and the disc contacting projection 20a of the clamp release slider 20 and driven. When a not shown eject switch or the like is depressed, the clamp release operation is started.

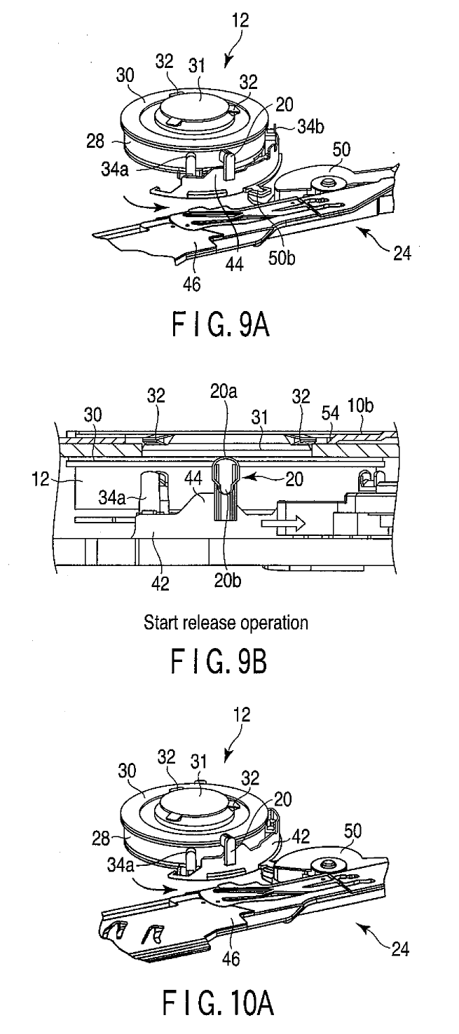

As shown in FIGS. 9A and 9B, when the clamp release operation is started, the clamp ring 42 is rotated counterclockwise by the cam drive mechanism 24, and the disc motor 12 and the clamp release slider 20 are caused to ascend by the lift cams 43a, 43b, 43c formed on the clamp ring and the release cam 44. When the phases of the lift cams 43a, 43b, 43c and the release cam 44 are set, the clamp release slider 20 reaches the clamp release position at which the disc contacting projection 20a comes into contact with the optical disc 11. The disc motor 12 ascends to an ascending position at which the inner peripheral portion of the optical disc 11 abuts against the locking rib 54 of the top cover 10b.

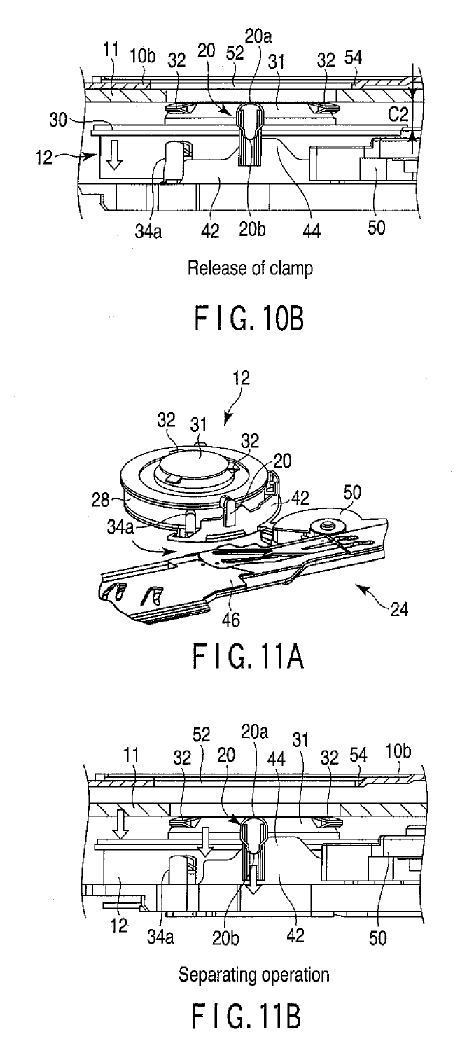

When the clamp ring 42 is further rotated counterclockwise in this state, the disc motor 12 is caused to descend in a state that the clamp release slider 20 is held at the clamp release position by the release cam 44 as shown in FIGS. 10A and 10B. During the descending operation, the optical disc 11 also starts to descend together with the disc motor 12, but the movement thereof is regulated since the optical disc 11 contacts with the disc contacting projection 20a of the clamp release slider 20. With this operation, the optical disc 11 clamped to the hub 31 of the disc motor 12 is released therefrom, only the disc motor 12 descends, and the optical disc 11 is held by the disc contacting projection 20a.

In this operation, since the clamp release slider 20 ascends to the clamp release position and is held thereat, the distance which the disc motor 12 descends from the position at which the clamp release slider 20 abuts against the optical disc, that is, a lap amount C2 can be sufficiently secured. With this operation, the clamped optical disc 11 is securely released.

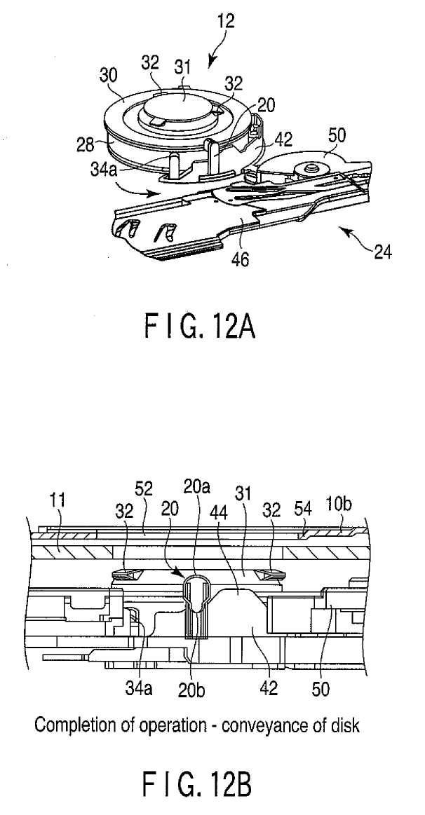

Subsequently, when the clamp ring 42 is further rotated counterclockwise as shown in FIGS. 11A and 11B, the disc motor 12, the clamp release slider 20 and the released optical disc 11 descend. The disc motor 12 moves to a descending position below beyond the drive position as shown in FIGS. 12A and 12B, and the clamp release slider 20 reaches the evacuate position which is sufficiently away from the optical disc.

During the descending operation, the optical disc 11 is held at a conveyance waiting position by an eject arm or the like of the not shown loading mechanism while it descends. With this operation, the hub 31 of the disc motor 12 and the disc contacting projection 20a of the clamp release slider 20 evacuate up to a position having a proper clearance with respect to the optical disc 11, and the optical disc is placed in a conveyance waiting state.

When the optical disc 11 is clamped to the hub 31 of the disc motor 12, operations opposite to the above series of operations are performed.

According to the optical disc drive apparatus arranged as described above, a clamped disc can be released at optimum timing and securely with a sufficient lap amount being set, by optionally controlling the clamp release slider for releasing clamp in synchronism with timing at which the disc motor ascends and descends. Further, when an optical disc is driven and when an optical disc is conveyed, a sufficient clearance can be set between the optical disc and the clamp release slider, and thus the degree of freedom of design and the operation allowance of the optical disc apparatus can be improved.

Further, since a relative approaching speed between a clamped optical disc and the clamp release slider can be set to be high, a clamp load can be reduced and power consumption of the loading motor that constitutes the slider lift mechanism can be reduced. Since a clamped disc can be released at a position farther away from a structure located therebelow, a recording surface of the disc can be protected and thus reliability of the disc can be improved.

The motor lift mechanism, which causes the disc motor to ascend and descend, and the slider lift mechanism, which causes the clamp release slider to ascend and descend, comprise the common clamp ring and the common cam drive mechanism. Accordingly, since the disc motor and the clamp release slider can be caused to ascend and descend in synchronism with each other at correct timing, reliability of a clamp release operation can be improved.

According to what has been described above, there can be provided an optical disc apparatus which can set the large lap amount and securely release a clamped disc as well as secure the clearance between a disc and other mechanical structures and has improved degree of freedom of design and allowance of motion.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the shape of the clamp release member is not limited to that of the slider described above and can be variously changed.

What is claimed is:

1. An optical disc apparatus comprising:
a disc motor comprising a turntable configured to hold an optical disc and a clamp portion configured to clamp the optical disc placed on the turntable, and configured to hold and rotate the optical disc;
a motor supporter configured to support the disc motor to be movable;
a motor lift configured to ascend and descend the disc motor among an ascending position, at which the clamp portion is configured to clamp the optical disc, a descending position, at which the disc motor is separated from the optical disc, and a disc drive position between the ascending position and the descending position, with respect to the optical disc loaded at a predetermined position;
a clamp release movable between a clamp release position, at which the clamp release is configured to contact with the optical disc in order to regulate movement of the optical disc, and an evacuate position at which the clamp release is separated from the optical disc; and
a clamp release lift configured to ascend and descend the clamp release in synchronization with the ascent and descent of the disc motor.

2. The optical disc apparatus of claim 1, wherein the motor lift and the clamp release lift are configured to ascend the clamp release to the clamp release position when the clamped disc is released, and are configured to descend the disc motor to the descending position in a state that the clamp release is held at the clamp release position.

3. The optical disc apparatus of claim 1, wherein the motor lift comprises an arc-shaped cam portion around the disc motor configured to rotate around a rotating shaft of the disc motor, a lift cam formed on the cam portion, an engaging portion projecting from the disc motor engaged with the lift cam, and a cam rotator configured to rotate the cam portion,
the motor support module comprises a lift guide configured to support and guide the disc motor, and a biasing member configured to bias the disc motor in a direction in which the engaging portion of the disc motor is brought into contact with the lift cam, and
the clamp release lift comprises a release cam formed on the cam portion and a biasing component configured to bias the clamp release in a direction in which the clamp release is configured to engage with the release cam.

4. The optical disc apparatus of claim 3, wherein the clamp release comprises a contacting portion configured to contact the optical disc, and a cam engaging portion engaging with the release cam, and is configured move in a direction parallel to the rotating shaft of the disc motor.

5. The optical disc apparatus of claim 3, wherein the lift cam and the release cam are formed with a phase shift in a direction in which the cam member is configured to rotate.

6. The optical disc apparatus of claim 1, wherein the cam rotator comprises:
a cam slider configured to move forward and backward in a direction intersecting the rotating shaft of the disc motor;
a loading motor configured to move the cam slider; and
a clamp lever configured to rotate about an axis parallel to the rotating shaft of the disc motor and comprising a first engaging portion engaged with the cam slider and a second engaging portion engaged with the cam portion, the clamp lever being configured to rotate the cam portion in accordance with the movement of the cam slider.
